(19) United States
(12) Patent Application Publication
(10) Pub. No.: US 2012/0159050 A1
(43) Pub. Date: Jun. 21, 2012

(54) MEMORY SYSTEM AND DATA TRANSFER METHOD

(75) Inventors: Hirokuni YANO, Tokyo (JP); Eiji Yoshihashi, Kanagawa (JP)

(73) Assignee: KABUSHIKI KAISHA TOSHIBA, Tokyo (JP)

(21) Appl. No.: 13/328,471

(22) Filed: Dec. 16, 2011

(30) Foreign Application Priority Data
Dec. 17, 2010 (JP) 2010-282290

(51) Int. Cl. G06F 12/00; G06F 12/10

(52) U.S. Cl. 711/103; 711/E12.058; 711/E12.008

(57) ABSTRACT

According to one embodiment, a memory system comprises a nonvolatile memory including a memory cell array and a read buffer and a controller configured to receive a read request and to issue a first read command and a second read command to the memory. When issuing the first read command, the memory transfers data of the first size from the memory cell array to the read buffer and outputs the data from the read buffer to the controller. When issuing the second read command, the memory transfers first data of the first size from the memory cell array to the read buffer, outputs the first data from the read buffer to the controller, and transfers second data of the first size from the memory cell array to the read buffer. The controller selects one command from the two commands according to the read request.

### CROSS-REFERENCE TO RELATED APPLICATIONS

This application is based upon and claims the benefit of priority from the prior Japanese Patent Application No. 2010-282290, filed on Dec. 17, 2010; the entire contents of which are incorporated herein by reference.

### FIELD

Embodiments described herein relate generally to a memory system and a data transfer method.

### BACKGROUND

As an external storage device used for a computer system, an SSD (Solid State Drive) with a flash memory having a memory cell array formed by NAND type non-volatile elements mounted attracts much attention. The SSD with the flash memory mounted has advantages such as high speed and weight reduction in comparison with a magnetic disk device.

In the conventional SSD, in order to hide a waiting time at reading out data from a flash memory, prefetch for previously reading out the data supposed to be requested by a host from the flash memory is performed and the performance is improved by an access pattern such as Sequential Read.

### BRIEF DESCRIPTION OF THE DRAWINGS

FIG. 1 is a block diagram showing a structure of an SSD according to a first embodiment;

FIG. 2 is a view for use in describing normal read;

FIG. 3 is a view for use in describing cache read;

FIG. 4 is a view showing an example of a data structure of an address conversion table;

FIG. 5 is a flow chart for use in describing an operation of the SSD according to the first embodiment at processing a read request received by a host device;

FIG. 6 is a view describing a division method in Step S5;

FIG. 7 is a flow chart for use in describing an operation of an SSD according to a second embodiment at processing a read request received from a host device;

FIG. 8 is a flow chart for use in describing an operation of an SSD according to a third embodiment at processing a read request received from a host device;

FIG. 9 is a flow chart for use in describing an operation of an SSD according to a fourth embodiment at processing a read request received from a host device;

FIG. 10 is a block diagram showing a structure of an SSD according to a fifth embodiment; and

FIG. 11 is a flow chart describing an operation of the SSD according to the fifth embodiment at processing a read request from a host device.

### DETAILED DESCRIPTION

In general, according to one embodiment, a memory system comprises a nonvolatile memory and a controller. The nonvolatile memory includes a memory cell array and a read buffer temporarily storing data of a first size read out from the memory cell array. The controller is configured to receive a read request including a host address and a read size and to issue a first read command and a second read command to the nonvolatile memory. When issuing the first read command, the nonvolatile memory transfers data of the first size from the memory cell array to the read buffer and outputs the data from the read buffer to the controller. When issuing the second read command, the nonvolatile memory transfers first data of the first size from the memory cell array to the read buffer, outputs the first data from the read buffer to the controller, and transfers second data of the first size having a physical address adjacent to the physical address of the first data from the memory cell array to the read buffer. The controller determines whether to use the first read command or to use the second read command according to at least one of the host address and the read size.

In the conventional SSDs, at performing a data transfer to a host device, there is a case where the time taken for internal read of a memory chip looks like latency to start a data transfer and as a result, efficiency for transferring data is deteriorated.

Exemplary embodiments of a memory system and a data transfer method will be explained below in detail with reference to the accompanying drawings. The present invention is not limited to the following embodiments. In the following embodiments, a description will be made by way of an example that applies the memory system according to the embodiments of the invention to the SSD; however, the subject to apply the memory system according to the embodiments of the invention is not limited to the SSD. For example, it can be applied to an auxiliary storage device such as a memory card and the like where a semiconductor memory and a controller for storing data in a non-volatile way are mounted.

Each function block in each embodiment can be realized by either hardware or software, or a combination of the both. Therefore, the description will be made as follows, from the viewpoint of the function, so that those skilled in the art may clearly understand that these function blocks can be any of the above case. Whether these functions are realized as hardware or as software depends on a concrete embodiment or a design restriction imposed on the whole system. Those skilled in the art can realize these functions in various ways, in every concrete embodiment and determination how to realize the above functions is included in the scope of the invention.

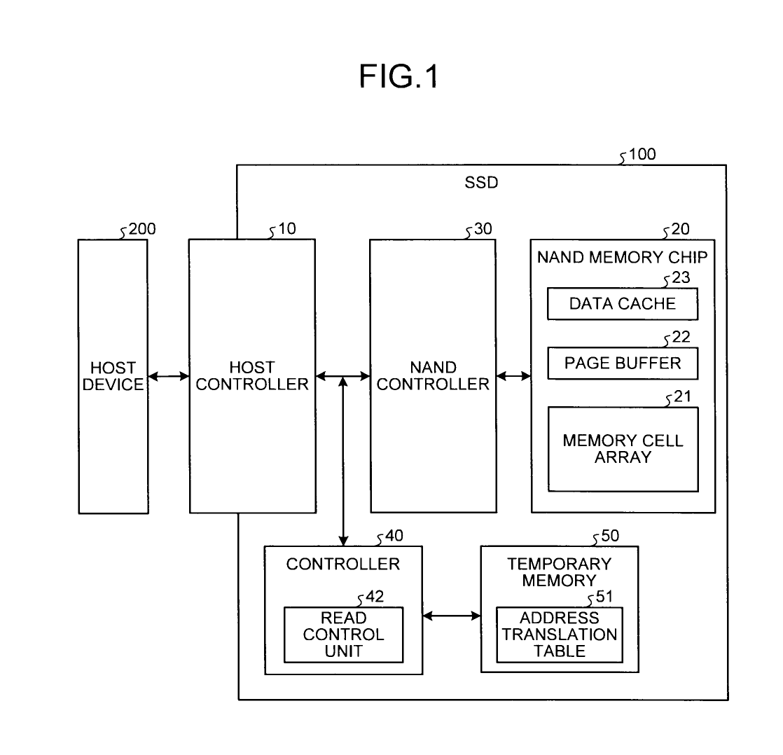

FIG. 1 is a block diagram showing a structure of an SSD according to a first embodiment. As shown in the figure, an SSD 100 is connected to a host device 200 such as a personal computer and the like through a communication interface such as ATA (Advanced Technology Attachment) standard and the like and works as an external storage device of the host device 200. A read/write request received by the SSD 100 from the host device 200 includes a host address (here, LBA: Logical Block Addressing) and a size of the data requested to read/write (here, it is the number of sectors and one sector is, for example, 512 bytes).

The SSD 100 includes a host controller 10, a NAND memory chip 20, a NAND controller 30, a controller 40, and a temporary memory 50. The host controller 10, the NAND controller 30, and the controller 40 form a controller which receives a read request from the host device 200, makes the NAND memory chip 20 output the data to be read as for the received read request in every reading and writing unit (page) called a page, and transfers the output data of every page size to the host device 200 sequentially.

The host controller 10 notifies the controller 40 of the write/read request (hereinafter, referred to as a host command) received from the host device 200. The host controller 10 transfers data between the host device 200 and the NAND memory chip 20 through the NAND controller 30. The data transfer between the host device 200 and the host controller 10 is performed by the sector size unit that is a unit of the request from the host device 200.

The controller 40 has a function of translating the host command received from the host device 200 through the host controller 10 and controlling the NAND controller 30 according to the command. The controller 40 includes a read control unit 41. The read control unit 41 translates the read request received from the host controller 10 and issues a NAND command for reading to the NAND controller 30.

The NAND memory chip 20 stores the data requested to write through the host command. The NAND memory chip 20 includes a memory cell array 21, formed by a NAND typed non-volatile memory elements, which has read/write units (pages) and erase units with a plurality of pages collected as what is called a block. The data for one page has a size obtained, for example, by adding a data unit having an integral multiple of the sector size to a redundant unit used for correcting errors. The NAND memory chip 20 inputs and outputs the data of one or a plurality of sector sizes requested to write/read from the host device 200 for every page, based on the NAND command received from the controller 40 through the NAND controller 30.

The NAND memory chip 20 includes a data cache 23 that is a first buffer for transmitting and receiving the transfer data of page size to and from the NAND controller 30 and a page buffer 22 (read buffer) that is a second buffer existing between the data cache 23 and the memory cell array 21. The page buffer 22 and the data cache 23 are formed, for example, by a SRAM.

In the writing mode, the NAND memory chip 20 receives the data transmitted from the NAND controller 30 into the data cache 23, transfers the received data to the page buffer 22, and after finishing the transfer, writes the data stored in the page buffer 22 into the memory cell array 21 for every page unit. In the reading mode, the NAND memory chip 20 reads out the read-requested data from the memory cell array 21 onto the page buffer 22 for every page unit, transfers the data from the page buffer 22 to the data cache 23 after the completion of reading, and transfers the data from the data cache 23 to the NAND controller 30.

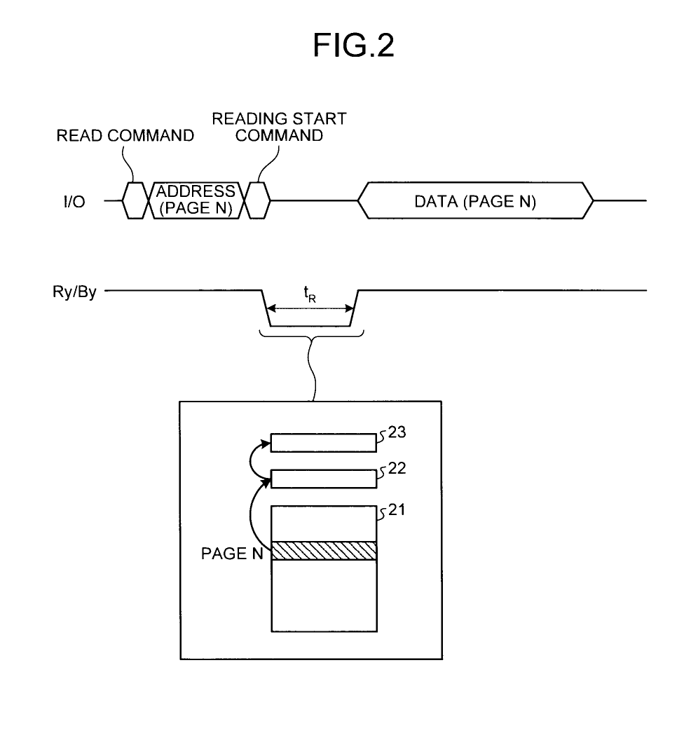

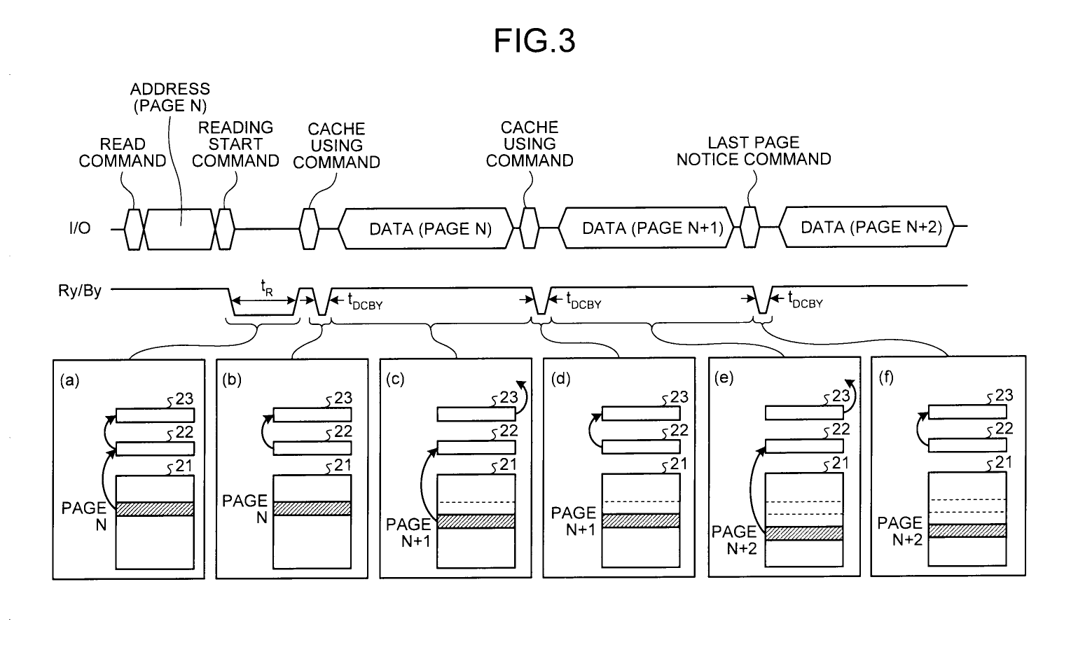

According to the first embodiment of the invention, the NAND memory chip 20 can carry out the two read operations: normal read for reading out only the data requested to read through the NAND command from the memory cell array 21 and outputting the same and cache read for outputting the data requested to read through the NAND command and reading out the data for one page stored in the adjacent address to the above requested data from the memory cell array 21 onto the page buffer 22. The NAND command for requesting the former reading operation is defined as a normal read command and the NAND command for requesting the latter reading operation is defined as a cache read command. FIG. 2 is a view for use in describing the normal read and FIG. 3 is a view for use in describing the cache read.

FIG. 2 shows the state of I/O signal, the state of Ry/By signal, and an operation within the NAND memory chip 20 when the state of the Ry/By signal is By, in the normal read mode. As shown in the figure, at first, the NAND controller 30 transmits a read command that is a command for notifying to the effect that transmission and reception starts as for the reading operation, an address where the data to be read is stored, and a reading start command that is a command for notifying the NAND memory chip 20 to the effect that the internal operation as for reading starts after the completion of the transmission of the address, to the NAND memory chip 20. The read command, the address, and the reading start command form the normal read command. Here, the address where the data to be read is stored is defined as an address of the page N in the memory cell array 21.

Upon receipt of the reading start command, the NAND memory chip 20 turns the Ry/By signal into the By state until finishing the processing for preparing the data to be read in the page buffer 22 (internal read). Specifically, the NAND memory chip 20 shifts the Ry/By signal from Ry to By after receiving the reading start command. The data is read out from the page N of the memory cell array 21 and the read out data is stored in the page buffer 22. The NAND memory chip 20 transfers the data stored in the page buffer 22 to the data cache 23.

The NAND memory chip 20 stores the data read out from the page N into the data cache 23 and shifts the Ry/By signal from the By state to the Ry state. The latency is described as tR while the Ry/By signal is in the By state. After the Ry/By signal returns to the Ry state, the data read out from the page N stored in the data cache 23 is transmitted to the NAND controller 30. The data within the data cache 23 is transmitted to the NAND controller 30, for example, in synchronization with RE (Read Enable) signal issued by the NAND controller 30.

FIG. 3 shows the state of the I/O signal, the state of the Ry/By signal, and the state within the NAND memory chip 20 at each point during the reading operation, in the cache read mode. Here, the data stored in the pages N to N+2 is read out from the memory cell array 21. As shown in the figure, at first, the NAND memory chip 20 receives the read command, the address (page N) of the first page where the data to be read is stored, and the reading start command, from the NAND controller 30.

The command and the address received by the NAND memory chip 20 up to this point are the same as those of the normal read command. Therefore, as shown in (a), after reception of the reading start command, the NAND memory chip 20 shifts the Ry/By signal from Ry to By. It reads out the data from the page N of the memory cell array 21 and stores the read out data into the page buffer 22. The NAND memory chip 20 stores the data stored in the page buffer 22 into the data cache 23. After storing the data read out from the page N into the data cache 23, the NAND memory chip 20 shifts the Ry/By signal from the By state to the Ry state. The time during which the Ry/By signal is in the By state is the same as tR.

After the Ry/By signal returns to Ry, the NAND controller 30 transmits a cache using command that is a command for notifying to the effect of carrying out the cache read to the NAND memory chip 20. Upon receipt of the cache using command, the NAND memory chip 20 reads out the data as for the page N stored in the page buffer 22 again and stores the read out data into the data cache 23 again, as shown in (b). During this time, the NAND memory chip 20 turns the Ry/By signal into the By state. The latency during which the Ry/By signal is in the By state is described as tDCBY. Since the processing for transferring the data from the page buffer 22 to the data cache 23 is a data transfer between the registers, this processing is carried out in a time extremely shorter than that of the internal read accompanying the access to the memory cell array 21. Therefore, the tDCBY is extremely smaller than tR.

When the Ry/By signal returns to the Ry state, the data read out from the page N stored in the data cache 23 is transmitted to the NAND controller 30. Here, as shown in (c), the NAND memory chip 20 transmits the data stored in the data cache 23 and at the same time, reads out the data from the page N+1 that is the page neighboring to the page N, and stores the read out data into the page buffer 22.

When the data as for the page N is transferred to the NAND controller 30, the NAND controller 30 transmits the cache using command again. Upon receipt of the cache using command, as shown in (d), the NAND memory chip 20 reads out the data as for the page N+1 stored in the page buffer 22 through the operation shown in (c) and stores the read out data into the data cache 23. During this processing, the NAND memory chip 20 turns the Ry/By signal into the By state. The latency during this processing is the same as tDCBY.

When the Ry/By signal returns to the Ry state, the data read out from the page N+1 stored in the data cache 23 is transmitted to the NAND controller 30. Here, as shown in (e), the NAND memory chip 20 transmits the data stored in the data cache 23 and at the same time, reads out the data from the page N+2 that is the page neighboring to the page N+1 and stores the read out data into the page buffer 22.

When the data as for the page N+1 is transferred to the NAND controller 30, the NAND controller 30 transmits the last page notice command for notifying that the next page is the final page of the data to be read according to the cache read. Upon receipt of the last page notice command, as shown in (f), the NAND memory chip 20 reads out the data as for the page N+2 stored in the page buffer 22 through the operation shown in (e) and stores the read out data into the data cache 23. During this processing, the NAND memory chip 20 turns the Ry/By signal into the By state. The latency during this processing is the same as tDCBY.

When the Ry/By signal returns to the Ry state, the data read out from the page N+2 stored in the data cache 23 is transmitted to the NAND controller 30, thereby finishing the cache read.

The read command, the address, the read command, one or a plurality of cache using commands, and the last page notice command form the cache read command. The cache using command may be used instead of the last page notice command.

In the case where the data of a plurality of pages having the physical addresses in series is a reading target from the host device 200, when the normal read shown in FIG. 2 is carried out for every page, the latency tR as for the internal read occurs every time of carrying out the normal read. When the cache read shown in FIG. 3 is carried out, the latency tR as for the internal read occurs at reading out the first page; however, since the data of the next page is pre-read onto the page buffer 22 at a time of finishing the transfer of the data for one page, the large latency such as tR doesn't occur but the data transfer of the next page can be started. According to the cache read, the waiting time taken for the internal read can be hidden and as a result, the data transfer can be efficiently performed between the host device 200 and the SSD 100.

According to the first embodiment, the read control unit 41 determines whether the NAND command issued to the NAND controller 30 is set as the normal read command or the cache read command according to the sector size (SC) included in the read request from the host device 200. Specifically, the read control unit 41 holds SCth as a threshold size, sets the issued NAND command as the cache read command when SC is larger than SCth, and sets the issued NAND command as the normal read command when SC is smaller than SCth. The symbol SCth is the value larger than one and the value corresponding to the size for a plurality of pages is adopted.

The NAND controller 30 queues the NAND commands transmitted from the controller 40 and issues the NAND commands queued sequentially to the NAND memory chip 20 according to the operation state of the NAND memory chip 20. The NAND controller 30 recognizes the operation state of the NAND memory chip 20, for example, according to the state of the Ry/By signal line. The NAND controller 30 carries out the data transfer between the NAND memory chip 20 and the host controller 10.

The temporary memory 50, formed by a DRAM and the like, stores an address conversion table 51 which describes a correspondence relation between the LBA included in the host command and the physical address where the corresponding data is stored in the memory cell array 21. The controller 40 updates the correspondence relation of the address conversion table 51 at writing the data requested to write from the host device 200 into the NAND memory chip 20 and obtains the physical address of the destination for storing the data requested to read, with reference to the address conversion table 51 at generating the NAND command as for reading.

The minimum management unit of the correspondence relation between the LBA and the physical address of the memory cell array 21 to be recorded in the address conversion table 51 is defined as the unit of an integral multiple of the sector size and the data for the unit is recorded in the NAND memory chip 20 in series. Since there is such a relation that the size of the address conversion table 51 becomes larger according as the management unit of the address conversion table 51 becomes smaller and that the size of the address conversion table 51 becomes smaller according as the management unit of the address conversion table 51 becomes larger, the management unit of the address conversion table 51 is determined by considering the capacity of the temporary memory 50 recording the address conversion table 51. For example, the block size unit, the page size unit, or the divided block or page unit, larger than the sector size, is used.

In the first embodiment, to make the description simple, the block size of the NAND memory chip 20 is defined as the address conversion unit. Specifically, the physical addresses for every block size region in the memory cell array 21 are aligned in the host address and the continuous data for the block size starting from the host address where the head address of the block is aligned is recorded in series in the continuous pages within the block also on the NAND memory chip 20.

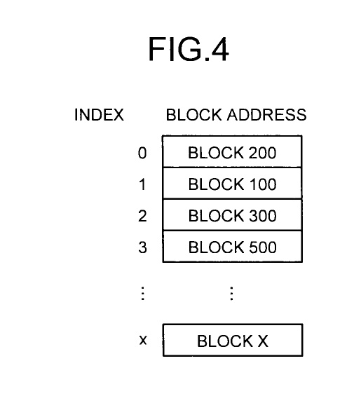

FIG. 4 is a view showing an example of the data structure of the address conversion table 51. As shown in the figure, the index of the address conversion table 51 is defined as the quotient (integer) obtained by dividing the host address (LBA) by the block size. For example, when the block size is 100 times as large as the sector size, since the data of the host address (LBA) 180 is 180/100=1 and a remainder 80, it means that the data is stored at from the position of 80^{th} sector from the leading block of the Block 100 stored in the index 1.

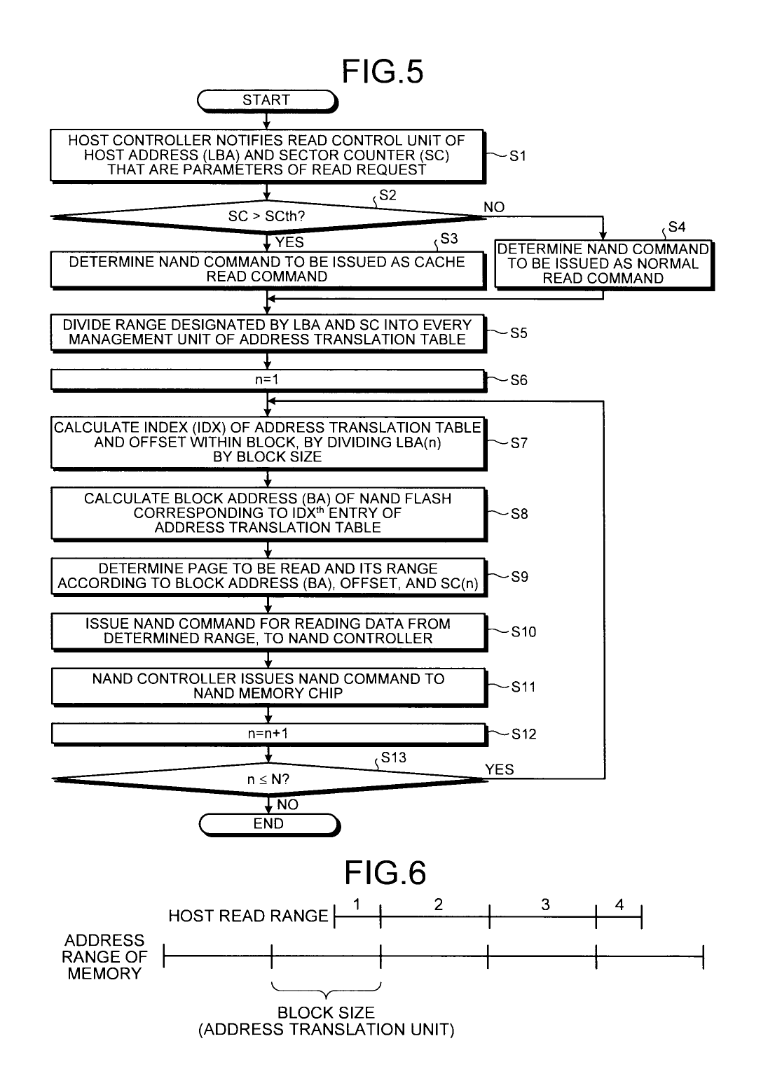

FIG. 5 is a flow chart for use in describing the operation of the SSD 100 according to the first embodiment of the invention when processing a read request received from the host device 200. When the host device 200 transmits a read request to the SSD 100, the host controller 10 notifies the read control unit 41 of the host address (LBA) that is a parameter of the received read request and the sector count (SC) (Step S1). The read control unit 41 determines whether the value of the SC is larger than the SCth or not (Step S2); when the SC is larger than the SCth (Step S2, Yes), it determines the NAND command to be issued as the cache read command (Step S3) and when the SC is smaller than the SCth (Step S2, No), it determines the NAND command to be issued as the normal read command (Step S4).

After Step S3 or Step S4, the read control unit 41 divides the LBA and the SC by the alignment unit of the block size that is the management unit of the address conversion table 51 (Step S5). The partition number is defined as N, the LEAs corresponding to the divided ranges are represented as the LBA (1), the LBA (2) to the LBA (N) respectively, and the sector counts in the respective ranges are represented as the SC (1), the SC (2) to the SC (N).

FIG. 6 is the view showing the division method in Step S5. As shown in the figure, the range to be read from the host device 200 is divided in the boundary of the block that is the address conversion table 51 and divided in four ranges in total.

After Step S5, the read control unit 41 initializes the parameter n for count for use in the loop processing of Step S7 to Step S13 to one (Step S6) and calculates the index (IDX) in the address conversion table 51 and the off set (OFFSET), by dividing the LBA (n) by the block size (Step S7). Concretely, the quotient obtained by dividing the LBA (n) by the block size is the IDX and the remainder is OFFSET. The read control unit 41 obtains the block address (BA) of the corresponding memory cell array 21 from the IDX^{th} entry in the address conversion table 51 (Step S8).

The read control unit 41 determines the page (address of the leading page) to be read and the range (for example, the number of pages) from the block address (BA), the offset (OFFSET), and the SC (n) (Step S9) and issues the type of the NAND command determined in Step S3 or Step S4 to the NAND controller 30 (Step S10).

For example, in the case where the issue of the normal read command is determined, the read control unit 41 issues a set of the read command, the address, and the reading start command for every page determined in Step S9. In the case where the issue of the cache read command is determined, the read control unit 41 issues the cache read command including the read command, the address of the leading page determined in Step S9, the read command, the cache using command for the number obtained by subtracting one from the number of pages determined in Step S9, and the last page notice command.

The NAND controller 30 issues the received NAND commands to the NAND memory chip 20 sequentially (Step S11). The data is output from the NAND memory chip 20 and the output data is transferred to the host device 200 sequentially.

The read control unit 41 increments the value of n by one (Step S12) and determines whether the value of n is the partition number N or less (Step S13). When n is N or less (Step S13, Yes), the processing moves to Step S7. When n is more than N (Step S13, No), the SSD 100 finishes the reading operation as for the received read request.

Although the above mentioned description has been made in the case where the correspondence relation between the host addresses and the physical addresses is described in every region of the block size in the memory cell array 21, in the address conversion table 51, the management unit of the address conversion table 51 may be any size as far as it is larger than the page size.

Although the description has been made in the case where the continuous data for the block size from the host address where the leading physical address of the block is aligned is recorded in the continuous pages within the block also on the NAND memory chip 20, the writing method is not limited to this. For example, the continuous data defined by the LBA and the SC may be preferably recorded in the continuous pages on the NAND memory chip 20.

Further, although the description has been made in the case where the read command, the address, the read command, one or more cache using commands, and the last page notice command form the cache read command, the cache using command may be used instead of the last page notice command. In other words, in this embodiment, when the cache read is performed, the data may be always read into the page buffer 22 previously, even in the case of reading the last page, instead of using the last page notice command generally used in the cache read command. This is applied to the following second to fifth embodiments.

When the last page notice command is not used, the NAND controller 30 may be provided with a function for determining whether the address of the data stored in the data cache 23 now and the address of the received normal read command or cache read command are in series or not. When the both addresses are in series, the NAND controller 30 issues the cache read command to the NAND memory chip 20 and carries out the data transfer from the page buffer 22; while when the both addresses are not in series, it issues the reset command to the NAND memory chip 20, erases the data stored in the page buffer 22 and the data cache 23, and carries out the read sequence from the beginning again. Therefore, when establishing access to the continuous pages, in a plurality of read requests received from the host device 200, the latency tR as for the internal read can be hidden, thereby improving the transfer efficiency further.

As described above, according to the first embodiment of the invention, the NAND memory chip 20 is designed to support the normal read command for transferring the data of the specified page size from the memory cell array 21 to the page buffer 22 and outputting the above data transferred to the page buffer 22 to the outside and the cache read command for transferring the data of the specified page size from the memory cell array 21 to the page buffer 22, outputting the above data transferred to the page buffer 22 to the outside, and transferring the data of the page size in the adjacent physical address to the specified data from the memory cell array 21 to the page buffer 22, and the controller (the host controller 10, the NAND controller 30, and the controller 40) is designed to determine whether the read command to be transmitted to the NAND memory chip 20 is defined as the normal read command or the cache read command, according to the data size (SC) included in the read request; therefore, at a time of performing a read request of fixed amount or more of data, the latency as for the internal reading of the read data for every page size can be hidden, thereby improving the transfer efficiency between the host device 200 and itself.

Since the controller is designed to determine to use the normal read command when the SC is smaller than a predetermined threshold size (SCth) by comparison between the SC and the SCth and to determine to use the cache read command when the SC is larger than the SCth, it is possible to determine which read command to use, only based on the host command, thereby speeding up the determination of a read command.

As a technique regarding the comparison example of the first embodiment of the invention, there is a technique for previously reading a page expected to be read next and caching the previously read data into the DRAM. According to the first embodiment of the invention, it is possible to read a page previously, without preparing the DRAM for cache; therefore, the manufacturing cost can be reduced compared with the above mentioned comparison example.

The structure of the SSD according to a second embodiment is the same as that of the first embodiment except for the read control unit; therefore, the detailed description about the structure of the SSD according to the second embodiment excluding the read control unit is omitted.

According to the second embodiment, after dividing the host address and the sector size from the host device 200 into every management unit of the address conversion table 51, the read control unit 41 determines the NAND command to be issued to the NAND controller 30 based on the comparison between the sector size SC (n) and the SCth of the divided region.

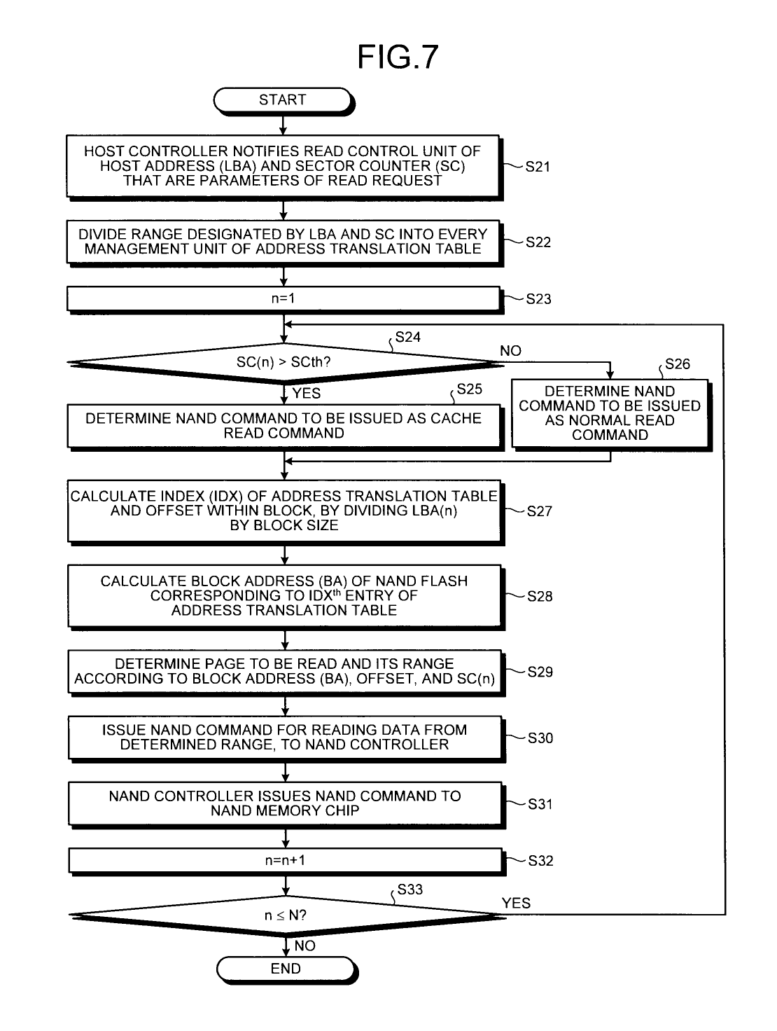

FIG. 7 is the flow chart for use in describing the operation of the SSD 100 according to the second embodiment of the invention at processing the read request received from the host device 200. When the host device 200 transmits the read request to the SSD 100, the host controller 10 notifies the read control unit 41 of the host address (LBA) and the sector count (SC) that are the parameters of the received read request (Step S21). The read control unit 41 divides the LBA and the SC by the alignment unit of the block size that is the management unit of the address conversion table 51 (Step S22). The division method is the same as that in the first embodiment.

The read control unit 41 initializes the parameter n for count for use in the loop processing of Step S24 to Step S33 to one (Step S23) and determines whether the value of the SC (n) is larger than the value of the SCth or not (Step S24). When the SC (n) is larger than the SCth (Step S24, Yes), the read control unit 41 determines the NAND command to be issued as the cache read command (Step S25) and when the SC is smaller than the SCth (Step S24, No), it determines the NAND command to be issued as the normal read command (Step S26).

After Step S25 or Step S26, the same processing as that in Step S7 to Step S12 is performed in Step S27 to Step S32.

After Step S32, the read control unit 41 determines whether the value of n is the value of the partition number N or less (Step S33). When n is N or less (Step S33, Yes), the processing moves to Step S24. When n is more than N (Step S33, No), the SSD 100 finishes the reading operation as for the received read request.

As mentioned above, even after the host address is divided into every region of the block size in the memory cell array 21, which read command to use can be determined at high speed based on the host command.

The structure of the SSD according to a third embodiment is the same as that in the first embodiment except for the read control unit; therefore, the detailed description of the structure of the SSD according to the third embodiment excluding the read control unit is omitted.

According to the third embodiment, the read control unit 41 switches the NAND command, based on whether it receives the read request in which the regions to be read are in series on the host address, a predetermined number of the times or more. The read control unit 41 holds the threshold Rth for determining the number of the read requests and the address information LBAexp for determining the continuity of the region to be read. The Rth is the value of one or more. In the case of receiving a read request with the LBAexp defined as the expected host address of the next read request, when the LBA of the above received read request and the held LBAexp are in agreement, the region to be read as for the above read request is determined to be continued to the region to be read as for the previous read request just received before the above read request.

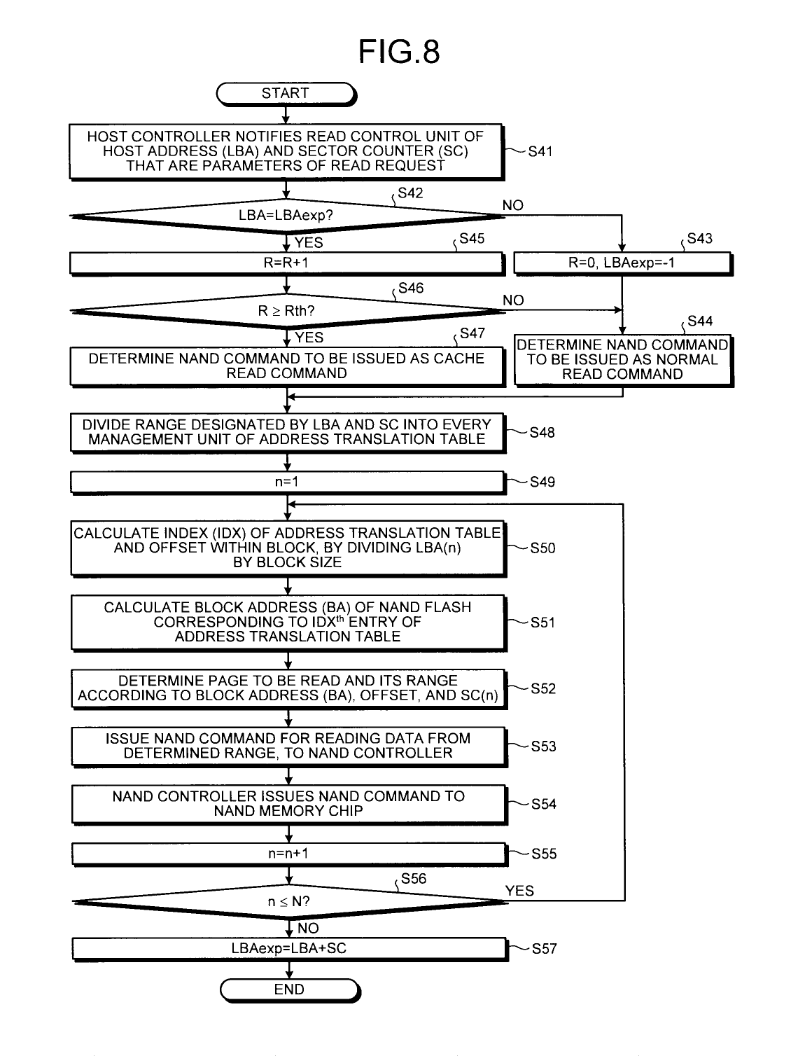

FIG. 8 is the flow chart for use in describing the operation of the SSD 100 according to the third embodiment of the invention at processing the read request received from the host device 200. When the host device 200 transmits the read request to the SSD 100, the host controller 10 notifies the read control unit 41 of the host address (LBA) and the sector count (SC) that are the parameters of the received read request (Step S41). The read control unit 41 determines whether the LBA is in agreement with the LBAexp previously held (Step S42); when the both values are not in agreement (Step S42, No), it initializes the value of R that is the count number of the read request targeting the continuous read region, to zero, sets the LBAexp as an invalid value (here, −1) which is not to be specified by the host device 200 (Step S43), and determines the NAND command to be issued as the normal read command (Step S44).

When the LBA is in agreement with the LBAexp (Step S42, Yes), the read control unit 41 increments the value of R by one (Step S45) and determines whether the value of R is the value of the Rth or more (Step S46). When the value of R is less than the value of the Rth (Step S46, No), the processing moves to Step S44. When the value of R is the value of Rth or more (Step S46, Yes), the read control unit 41 determines the NAND command to be issued as the cache read command (Step S47).

After Step S44 or Step S47, the same processing as that in Step S5 to Step S12 is carried out in Step S48 to Step S55. After Step S55, the read control unit 41 determines whether the value of n is the partition number N or less (Step S56). When n is N or less (Step S46, Yes), the processing moves to Step S50. When n is more than N (Step S46, No), the read control unit 41 updates the LBAexp to the value obtained by adding the SC to the LBA (Step S57) and the SSD 100 finishes the reading operation as for the received read request.

For example, in the case where the data smaller than the size obtained by multiplying the SCth by the size for the unit sector is the target for reading in a plurality of read requests and the read ranges (access ranges) as for the respective read requests are in series on the host address, it is possible to hide the latency as for the internal read of the respective data of the page size unit forming the read ranges specified by the read requests, in the mode of selecting the cache read. According to the third embodiment of the invention, in order to output the data to be read as for the read request to be processed, the controller is designed to determine whether the respective access ranges as for the above read request and a predetermined number or more of the read requests previously received before the above read request are in series on the host address; it determines to use the normal read command when the above access ranges are not in series, and determines to use the cache read command when the above access ranges are in series; therefore, it can carry out the cache read in the above mentioned situation and as a result, the transmission efficiency can be improved.

The structure of the SSD according to a fourth embodiment is the same as that of the first embodiment except for the read control unit; therefore, the detailed description of the structure of the SSD according to the fourth embodiment excluding the read control unit is omitted.

According to the fourth embodiment, the read control unit 41 switches the NAND command, based on whether it receives the read request in which the regions to be read are in series on the host address, a predetermined number of the times or more and based on the value of the SC. Namely, the SSD according to the fourth embodiment is formed by combination of the first embodiment and the third embodiment.

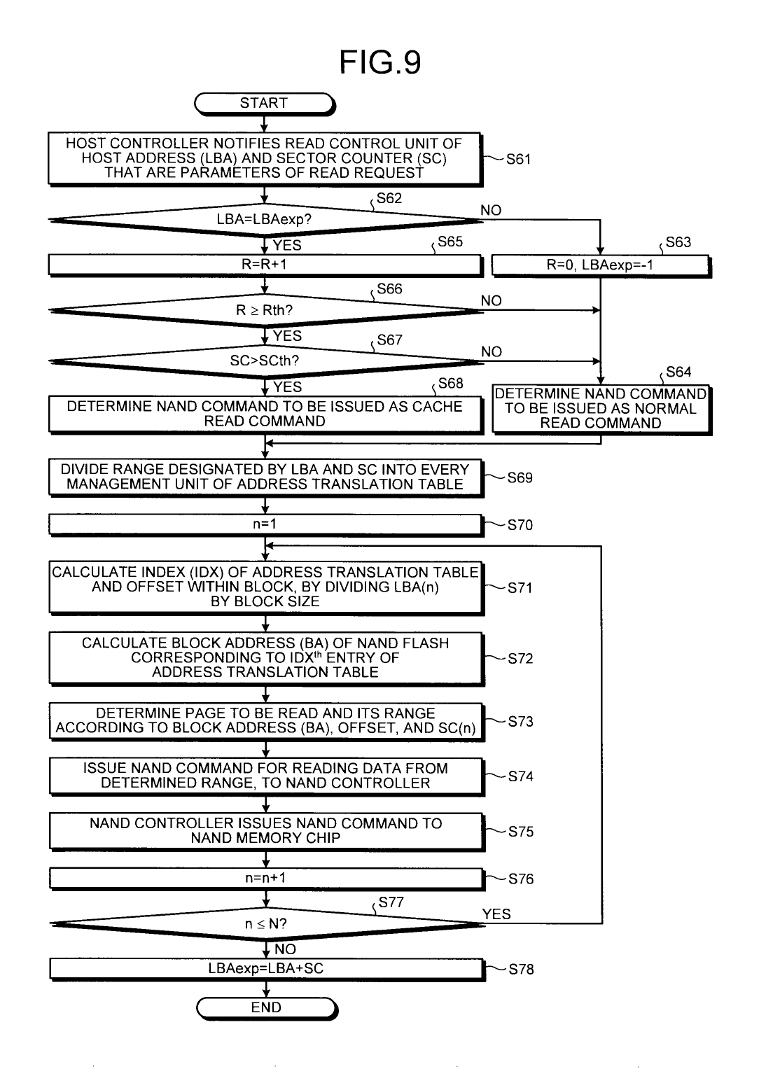

FIG. 9 is the flow chart for use in describing the operation of the SSD 100 according to the fourth embodiment of the invention at processing the read request received from the host device 200. When the host device 200 transmits a read request to the SSD 100, the host controller 10 notifies the read control unit 41 of the host address (LBA) and the sector count (SC) that are the parameters of the received read request (Step S61). The read control unit 41 determines whether the LBA and the LBAexp previously held are in agreement or not (Step S62); when the both values are not in agreement (Step S62, No), it initializes the value of R that is the count number of the read request targeting the continuous read region, to zero, sets the LBAexp as the invalid value (here, −1) which is not specified by the host device 200 (Step S63), and determines the NAND command to be issued as the normal read command (Step S64).

When the LBA and the LBAexp are in agreement (Step S62, Yes), the read control unit 41 increments the value of R by one (Step S65) and determines whether the value R is the value of Rth or more (Step S66). When the value of R is less than the value of Rth (Step S66, No), the processing moves to Step S64. When the value of R is the value of Rth or more (Step S66, Yes), the read control unit 41 determines whether the value of the SC is larger than the SCth (Step S67); when the SC is larger than the SCth (Step S67, Yes), it determines the NAND command to be issued as the cache read command (Step S68). When the SC is smaller than the SCth (Step S67, No), the processing moves to Step S64.

After Step S64 or Step S68, the same processing as that in Step S48 to Step S57 according to the third embodiment is performed in Step S69 to Step S78 and the SSD 100 finishes the reading operation as for the received read request.

In this way, the SSD may be mounted in the combination of the first embodiment and the third embodiment.

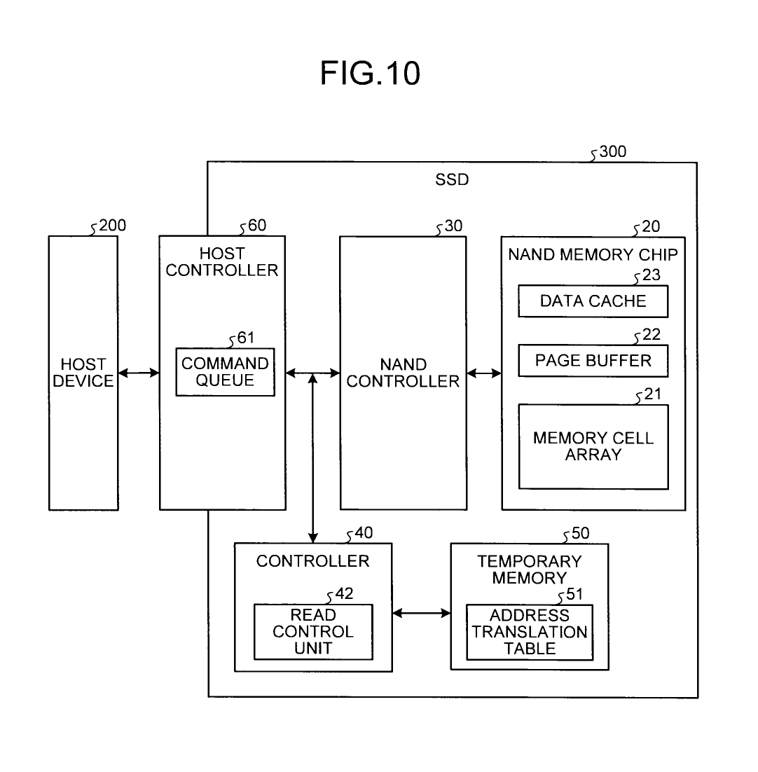

FIG. 10 is a block diagram showing the structure of the SSD of the fifth embodiment.

FIG. 10 is a block diagram showing the structure of the SSD according to a fifth embodiment. As shown in the figure, an SSD 300 according to the fifth embodiment is different from that of the first embodiment in the structure of a host controller 60 and a read control unit 42. In the description of the fifth embodiment, the detailed description of the structure except for the host controller 60 and the read control unit 42 is omitted.

According to the SATA standard that is one of the ATA standards, a function called NCQ (Native Command Queuing) is provided, which stores the read/write commands toward the HDD into a queue and rearranges the read/write commands stored into the queue in an efficient order, to perform the commands (out-of-order-execution). The host controller 60 includes a command queue 61 for queuing the host commands transmitted from the host device 200 by using the NCQ function. When transmitting a read request to the read control unit 42, the host controller 60 reads out the host address included in the read request stored in the command queue 61 next to the above read request and transmits the read host address to the read control unit 42.

The read control unit 42 judges the continuity of the region to be read, according to the read request to be processed, the host address included in the read request next to the read request to be processed received from the host controller 60.

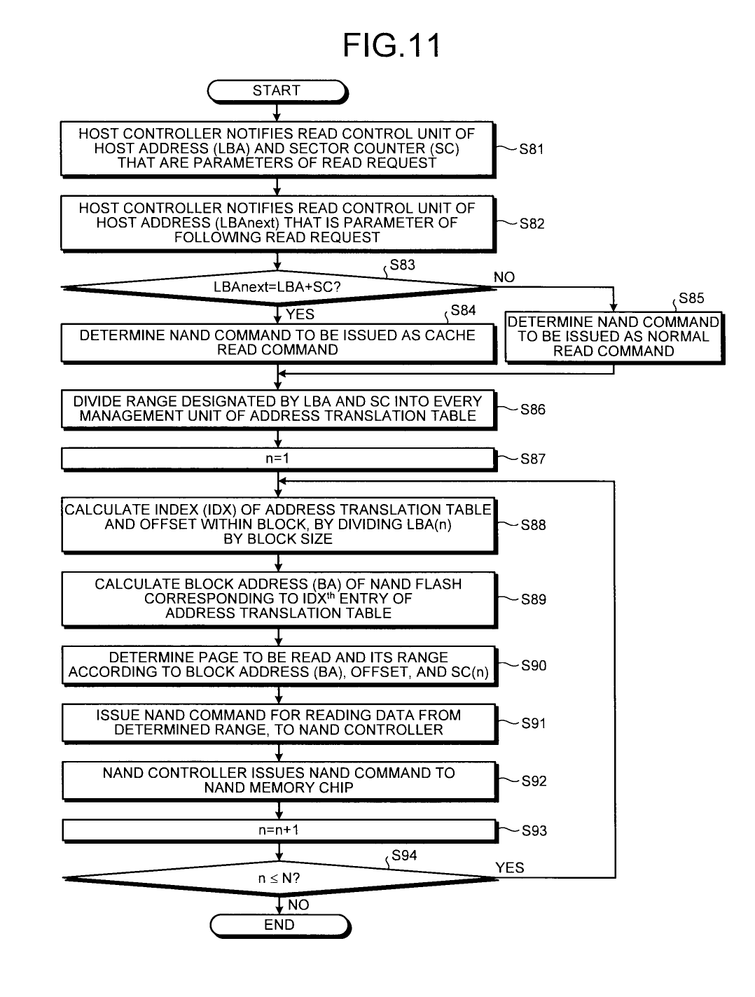

FIG. 11 is the flow chart for use in describing the operation of the SSD 300 according to a fifth embodiment of the invention at processing the read request received from the host device 200. The host controller 60 accumulates and stores the received host commands in the command queue 61 in the order of receiving. The host controller 60 takes out the read request to be processed from the command queue 61 and notifies the read control unit 42 of the host address (LBA) and the sector count (SC) that are the parameters of the read request to be processed (Step S81).

The host controller 60 reads out the host address (LBAnext) that is the parameter of the following read request next to the read request to be processed and transmits the read LBAnext to the read control unit 42 (Step S82). When the following read request next to the read request to be processed is not stored in the command queue 61, the host controller 60 may set the LBAnext as an invalid value (for example, −1) which is not specified by the host device 200.

The read control unit 42 determines whether the total value of the LBA and the SC is in agreement with the LBAnext (Step S83); when the both values are in agreement (Step S83, Yes), it determines the NAND command to be issued as the cache read command (Step S84), and when the both values are not in agreement (Step S83, No), it determines the NAND command to be issued as the normal read command (Step S85).

After Step S84 or Step S85, the same processing as that in Step S5 to Step S13 in the first embodiment is carried out in Step S86 to Step S94 and the SSD 300 finishes the reading operation as for the read request to be processed.

As mentioned above, since the controller includes the command queue 61 which accumulates and stores the read request received from the host device 200, and it is designed to determine whether the access ranges of the read request to be processed and the following read request next to the read request to be processed stored in the command queue 61 are in series on the host address, determine to use the normal read command when the above mentioned respective access ranges are not in series, and determine to use the cache read command when the above access ranges are in series, it is possible to determine whether the cache read is used or not, based on the relation with the next read request and even at processing the first received read request, when the transmission efficiency is expected to be improved by the cache read, the corresponding read request can be processed through the cache read.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory including a memory cell array and a read buffer temporarily storing data of a first size read out from the memory cell array; and
a controller configured to receive a read request including a host address and a read size and to issue a first read command and a second read command to the nonvolatile memory, wherein
when issuing the first read command, the nonvolatile memory transfers data of the first size from the memory cell array to the read buffer and outputs the data from the read buffer to the controller, and
when issuing the second read command, the nonvolatile memory transfers first data of the first size from the memory cell array to the read buffer, outputs the first data from the read buffer to the controller, and transfers second data of the first size having a physical address adjacent to the physical address of the first data from the memory cell array to the read buffer, and
the controller determines whether to use the first read command or to use the second read command according to at least one of the host address and the read size.

2. The memory system according to claim 1, wherein the controller is configured to
compare the read size with a threshold size,
when the read size is smaller than the threshold size, use the first read command, and
when the read size is larger than the threshold size, use the second read command.

3. The memory system according to claim 2, further comprising:
a temporary memory configured to record an address translation table indicating correspondence relationships between the host addresses and the physical addresses in the memory cell array, wherein
the address translation table translates the host address to the physical address by a second size larger than the first size,
the controller is configured to acquire a plurality of divided read sizes by dividing an access range designated by the host address and the read size by the second size and compare each of the plurality of divided read sizes with the threshold size.

4. The memory system according to claim 1, wherein
the controller determines whether to use the first read command or to use the second read command according to whether a first access range designated by a current read request and a second access range designated by a preceding read request are continuous on the host addresses.

5. The memory system according to claim 4, wherein
when the first access range and the second access range are not continuous, the controller is configured to use the first read command, and
when the first access range and the second access range are continuous, the controller is configured to use the second read command.

6. The memory system according to claim 4, wherein
in comparison between the read size as for the read request to be processed and the predetermined threshold size,
when the first access range and the second access range are not continuous or the read size is smaller than the threshold size, the controller is configured to use the first read command, and
when the first access range and the second access range are continuous and the read size is larger than the threshold size, the controller is configured to use the second read command.

7. The memory system according to claim 1, wherein
the controller
includes a command queue which records the read request received from the host device,
determines whether a first access range designated by a current read request and a second access range designated by a following read request recorded in the command queue are continuous on the host addresses,
when the first access range and the second access range are not continuous, the controller is configured to use the first read command, and
when the first access range and the second access range are continuous, the controller is configured to use the second read command.

8. The memory system according to claim 1, wherein
the nonvolatile memory is a NAND type flash memory.

9. The memory system according to claim 1, wherein
the first size is equal to a page size that is a data write unit into the memory cell array and a data read unit from the memory cell array.

10. The memory system according to claim 3, wherein
the second size is equal to a block size that is a data erase unit in the memory cell array.

11. A method for reading data from the nonvolatile memory including a memory cell array and a read buffer temporarily storing data of a first size read out from the memory cell array, the method comprising:
receiving a read request including a host address and a read size and issuing a first read command and a second read command to the nonvolatile memory;
when issuing the first read command, transferring data of the first size from the memory cell array to the read buffer and outputting the data from the read buffer to outside the nonvolatile memory;
when issuing the second read command, transferring first data of the first size from the memory cell array to the read buffer, outputting the first data from the read buffer to outside the nonvolatile memory, and transferring second data of the first size having a physical address adjacent to the physical address of the first data from the memory cell array to the read buffer; and
determining whether to use the first read command or to use the second read command according to at least one of the host address and the read size.

12. The data transfer method according to claim 11, comprising:
comparing the read size with a threshold size,
when the read size is smaller than the threshold size, issuing the first read command, and
when the read size is larger than the threshold size, issuing the second read command.

13. The data transfer method according to claim 12, comprising:
recording an address translation table indicating correspondence relationships between the host addresses and the physical addresses in the memory cell array, wherein
the address translation table translates the host address to the physical address by a second size larger than the first size,
dividing an access range designated by the host address and the read size by the second size, and
comparing each of the plurality of divided read sizes with the threshold size.

14. The data transfer method according to claim 11, comprising:
determining whether to use the first read command or to use the second read command according to whether a first access range designated by a current read request and a second access range designated by a preceding read request are continuous on the host addresses.

15. The data transfer method according to claim 14, comprising:
when the first access range and the second access range are not continuous, issuing the first read command, and
when the first access range and the second access range are continuous, issuing the second read command.

16. The data transfer method according to claim 14, comprising:
comparing between the read size as for the read request to be processed and the predetermined threshold size,
when the first access range and the second access range are not continuous or the read size is smaller than the threshold size, issuing the first read command, and
when the first access range and the second access range are continuous and the read size is larger than the threshold size, issuing the second read command.

17. The data transfer method according to claim 11, comprising:
recording the read request received from the host device,
determining whether a first access range designated by a current read request and a second access range designated by a following read request recorded in the command queue are continuous on the host addresses,
when the first access range and the second access range are not continuous, issuing the first read command, and
when the first access range and the second access range are continuous, issuing the second read command.

18. The data transfer method according to claim 11, wherein
the nonvolatile memory is a NAND type flash memory.

19. The data transfer method according to claim 11, wherein
the first size is equal to a page size that is a data write unit as for the memory cell array and a data read unit from the memory cell array.

20. The data transfer method according to claim 13, wherein
the second size is equal to a block size that is a data erase unit in the memory cell array.
